(19) United States
(12) Patent Application Publication
(10) Pub. No.: US 2021/0354448 A1
(43) Pub. Date: Nov. 18, 2021

(54) PRINTING APPARATUS AND METHOD

(71) Applicant: Suzhou Ruifa Printing Technology Co.,Ltd, Suzhou (CN)

(72) Inventor: Yonglin Xie, Suzhou (CN)

(21) Appl. No.: 17/316,761

(22) Filed: May 11, 2021

(30) Foreign Application Priority Data
May 13, 2020 (CN) 2020103860791

(51) Int. Cl. B41J 2/045

(52) U.S. Cl. CPC B41J 2/04508; B41J 2/04586

(57) ABSTRACT

The present application proposes a printing apparatus, including n printheads arranged along the first direction, each printhead communicating with at least two different inks; a printing medium opposing to the printheads, the printing medium configured to rotate around a rotational axis; a motion controller that controls the motions of the printheads and the printing medium; a printing driver that controls the printing of the printheads; the printing medium being divided into s printing areas along the first direction, such that each printing area is configured to be printed by a printhead, where s and n are positive integers greater than 1. The printing apparatus and printing method proposed in this invention reduce the relative moving distance between the printheads and the printing medium during the printing process by dividing the printing area into multiple printing areas, thereby reducing the overall printing time and increasing the printing speed.

### FIELD OF THE INVENTION

The present invention relates to the field of inkjet printing technology and more particularly to a printing apparatus and method.

### BACKGROUND OF THE INVENTION

In the inkjet printing technology, ink is ejected through the nozzles of the inkjet printhead to form ink droplets based on printing image data when the inkjet printhead and the printing medium move relative to each other. The ink droplets fly through the space between the inkjet printhead and the printing medium and strike the printing medium at defined positions, therefore completing formation of the desired print image by controlling formation of each ink drop.

In current digital drum printing practice, a printing medium such as textile or paper is fitted on the drum and printed continuously to effectively improve the printing efficiency. However, the existing digital drum printing apparatus, such as the technical solution disclosed in JP2019123960, includes multiple printheads, each of which prints only one color of ink. The printheads are arranged in a straight line, and the entire printing medium has to pass through all the printheads loaded with different color inks to complete a print. The distance that the printing medium passes through the printheads along the straight line is equal to the length of the printing medium in the straight line direction plus the length of all the printheads arranged along the straight line direction. Therefore, the printing speed is determined by the linear motion speed along the straight line and the above distance. In addition, JP2019123960 only includes a single drum. After finishing printing each part, a unprinted part needs to be loaded and then the printing can be resumed, consequently causing printing delay. In order to shorten the delay due to part loading, CN106274081A discloses a method in which one printhead can print on multiple drums. This method allow printing on one drum while loading and unloading printing media on other drums, thereby shortening the delay of parts replacement and improving printing efficiency. However, the printing speed for a single drum has not increased. To improve printing speed on a single drum, CN110481157A discloses a drum printing apparatus, in which the printing direction of the printhead (i.e. the printhead motion direction) and the drum rotational axis form an included angle, and the printhead and the drum move continuously and synchronously during printing. However, due to the included angle, after the printhead travels a certain distance, there will be no printing medium underneath it. Therefore, this printing method limits the length of the printing medium and cannot meet the printing requirements when the printing medium is longer. What is still needed to be solved is how to further increase the printing speed of one-drum printing, as well as meeting the needs of printing on media with various lengths.

### SUMMARY OF THE INVENTION

According to an aspect of the present invention a printing apparatus includes a plurality of n printheads arranged along a first direction, each of the printheads in fluid connection with at least two different inks; a printing medium disposed opposite to the printheads, the printing medium configured to rotate around a rotation axis; a motion controller that controls the motion of the printhead and the motion of the printing medium; a print driver that controls the printing of the printheads; where the printing medium is divided into s printing areas along the first direction, where each printing area is printed by a printhead and where s and n are positive integers and greater than 1.

According to another aspect of the present invention, a printing method includes arranging n printheads along a first direction; connecting a motion controller to the printheads and the printing medium; dividing the printing medium into s printing areas along the first direction; using the motion controller to drive the printing medium to rotate around the rotational axis and to move the printheads relative to the printing medium along the first direction; and using the print driver to control the printheads to print patterns on the printing medium, such that one printing area is printed by one printhead.

The printing apparatus and printing method proposed in the present invention shorten the relative motion distance between the printheads and the printing medium during printing process by dividing the printing medium into multiple printing areas and using multiple printheads with a variety of different inks to print, thereby reducing the overall printing completion time and increasing the printing speed.

The fastest printing speed can be achieved by setting the pitches of the printheads along the first direction to be substantially equal, where the lengths of the printing areas are equal, and the pitch of the printheads and the length of the printing areas are substantially equal. In addition, when the number of printheads does not match the number of printing areas, the printheads can be used alternately to balance the usage frequency of each printhead, so as to avoid various problems caused by over or under utilization of the printheads.

### BRIEF DESCRIPTION OF THE DRAWINGS

FIG. 1a shows a schematic diagram of a printing apparatus according to an embodiment;

FIG. 1b shows a schematic view of a portion of the printing apparatus shown in FIG. 1;

FIG. 2a shows a schematic view of a printhead including three printing units, according to an embodiment;

FIG. 2b shows a schematic view of a printhead including four printing units, according to an embodiment;

FIG. 2c shows a schematic view of a printhead including four printing units that are inclined relative to a direction of printhead motion, according to an embodiment;

FIG. 2d shows a schematic view of a printhead including four printing units that are arranged perpendicular to a direction of printhead motion, according to an embodiment;

FIG. 3a shows a schematic view of a printing unit including nozzles that are arranged in a row along the direction of printhead motion, according to an embodiment;

FIG. 3b shows a schematic view of a printing unit including nozzles that are arranged in a row inclined relative to the direction of printhead motion, according to an embodiment;

FIG. 3c shows a schematic view of a printing unit including nozzles that are arranged in two rows along the direction of printhead motion, according to an embodiment.

FIG. 3d shows a schematic view of a printing unit including nozzles that are arranged in four rows along the direction of printhead motion, according to an embodiment.

FIG. 4a shows a top view of the printing apparatus including three printheads each including four printing units that are inclined relative to a direction of printhead motion, according to an embodiment;

FIG. 4b shows a top view of the printing apparatus including three printheads each including four printing units that are arranged along a direction of printhead motion, according to an embodiment;

FIG. 4c shows a top view of the printing apparatus including three printheads each including four printing units that are arranged perpendicular to a direction of printhead motion, according to an embodiment;

FIG. 5 is a schematic diagram of a printing apparatus according to an embodiment;

FIG. 6 is a schematic cross-sectional view of the printing medium and the printheads;

FIG. 7 is a schematic view of a printing apparatus during printing according to an embodiment;

FIG. 8 is a schematic view of the printing apparatus at the end of printing according to an embodiment;

FIG. 9-1 to FIG. 9-6 are schematic views of the printing apparatus during a printing process according to an embodiment;

FIG. 10-1 to FIG. 10-6 are schematic views of the printing apparatus during a printing process according to an embodiment;

FIG. 11-1 to FIG. 11-3 are schematic views of the printing apparatus during a printing process according to an embodiment;

FIG. 12 is a schematic view of a printing apparatus according to an embodiment;

FIG. 13-1 to FIG. 13-2 are schematic views of the printing apparatus during a printing process according to an embodiment;

FIG. 14 is a schematic view of a printing apparatus according to an embodiment;

FIG. 15-1 to 15-3 are schematic views of the printing apparatus during a printing process according to an embodiment;

FIG. 16 is a schematic view of a printing apparatus according to an embodiment;

FIG. 17 is a schematic diagram of a printing apparatus according to an embodiment;

FIG. 18 is a schematic diagram of a printing apparatus proposed by an embodiment;

FIG. 19 is a schematic diagram of a printing apparatus according to an embodiment;

FIG. 20 is a schematic diagram of a printing apparatus according to an embodiment; and

FIG. 21 is a schematic diagram of the structure of a printing apparatus according to an embodiment.

It is to be understood that the attached drawings are for purposes of illustrating the concepts of the invention and may not be to scale. Identical reference numerals have been used, where possible, to designate identical features that are common to the figures.

### DETAILED DESCRIPTION OF THE INVENTION

In the description of this invention, it should be noted that the terms “center”, “upper”, “lower”, “left”, “right”, “vertical”, “horizontal”, “inner”, “outer”, “top”, “bottom”, “above”, “below”, etc. indicate orientation or positional relationship based on the orientation or positional relationship shown in the drawings. They are used to facilitate the description of the present invention and simplify the description, rather than to indicate or imply that the devices or elements referred to must have specific orientations, specific oriented structures and operations. Therefore, they cannot be understood as a limitation of the present invention. The terms “first”, “second”, “third” are for descriptive purposes only, and cannot be understood as indicating or implying relative importance. In addition, unless otherwise clearly stipulated and defined, the terms “mount”, “connect”, “connection” should be understood in a broad sense, for example, it can be a fixed connection, a detachable connection, or an integral connection; it also can be mechanical connection or electrical connection; it can be directly connected or indirectly connected through an intermediate medium, or it can be an internal connection between two components. For those skilled in the art, the specific meanings of the above terms used herein can be understood in specific circumstances.

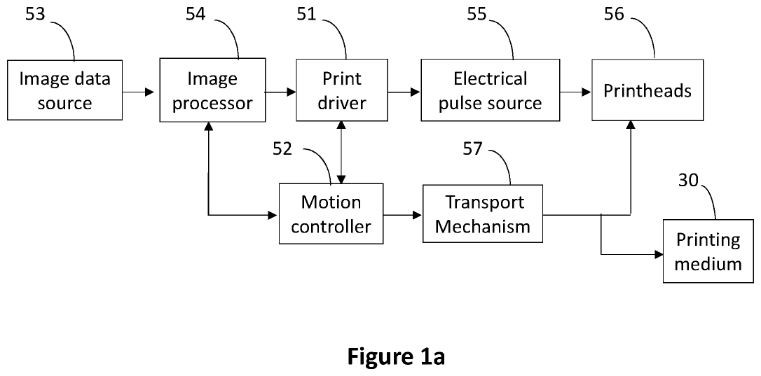

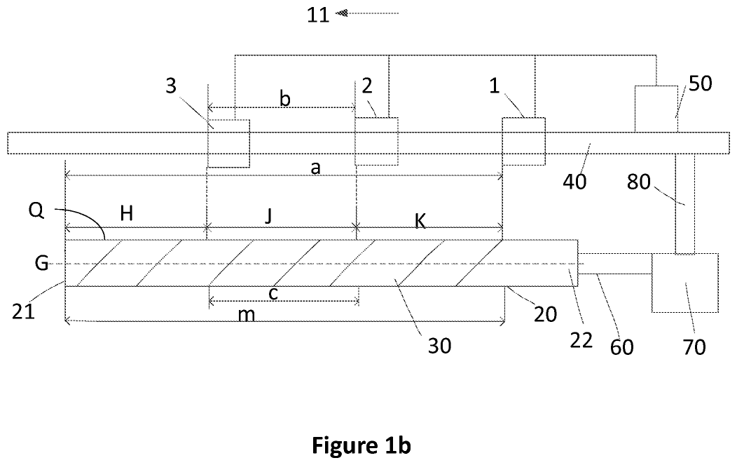

In reference to FIG. 1a, the printing apparatus includes a motion controller 52 and a print driver 51. The motion controller 52 controls the motion of the printhead 56 and the printing medium 30 through a transport mechanism 57. The print driver 51 controls the printing of the printhead 56. The motion controller 52 and the transport mechanism 57 can provide rotational and linear motion and control. The image data source 53 provides image data, which is translated by the image processor 54 into commands for printing. The term “image” is meant herein to include any pattern of dots specified by the image data. It can include graphics or text images. It can also include various 2D or 3D dot patterns suitable for printing functional devices or three-dimensional structures if suitable inks are used in the printing. The motion controller 52 feeds back the position information of each printhead 56 and the printing medium 30 to the print driver 51 and the image processor 54 in real time. The image processor can provide the image data according to the relative position of the printheads 56 to the printing medium 30. The print driver 51 sends output signals to the electrical pulse source 55 according to the image data translated by the image processor 54. And the electrical pulse source 55 sends the electrical pulse waveform to the printhead 56. The printhead 56 can also feed back information such as the temperature of the printhead to the print driver 51 in real time to adjust print parameters (such as the ink ejection voltage waveform). The printing apparatus includes at least one printhead. According to the positions of the printheads 56 and the printing medium 30, the print driver 51 instructs the printheads 56 when to start printing and when to end printing, and controls each printhead 56, each printing unit therein, and each nozzle therein throughout the entire printing process according to the desired printing image patterns.

As shown in FIG. 1b, the printing apparatus includes three identical printheads arranged along the direction 11, which are a first printhead 1, a second printhead 2, and a third printhead 3, respectively. The printing apparatus also includes a drum 20, a guide rail 40, a transporter 50, a drive shaft 60, and a motor 70, forming the transport mechanism 57 of the printing apparatus in FIG. 1a. For clarity, the detailed connection between the controller and transport mechanism and mounting structures are omitted in the figures. The guide rail 40 extends longitudinally along the direction 11, and the printheads are mounted on the guide rail 40 and distributed along the direction 11. The drum 20 has a rotational axis G (indicated by a dashed line in the FIG. 1b) and can be driven to rotate around the axis G. The printing medium 30 can be disposed on the surface of the drum 20. The motion controller 52 issues commands to the motor 70 that drives the drive shaft 60 to rotate, and then the drive shaft 60 rotates the drum 20. By controlling the drum 20, the rotation of the printing medium 30 disposed thereon can be controlled. The drum 20 rotates around the rotation axis G, and causes the printing medium 30 attached to its surface to rotate around the G axis. The motion controller 52 also controls linear motions of the printheads on the guide rail 40 through the transporter 50. The transporter 50 can be connected to the first printhead 1, the second printhead 2 and the third printhead 3 respectively, or alternatively can be connected to a common movable mechanical structure on which three printheads are mounted together, so that the three printheads can be moved linearly back and forth on the guide rail along the direction 11.

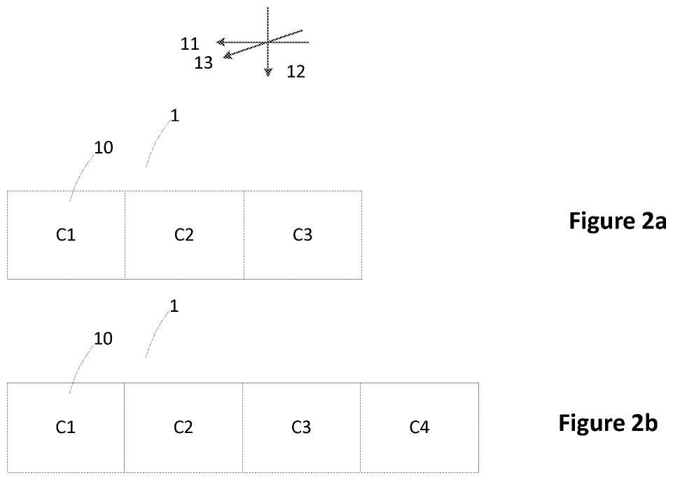

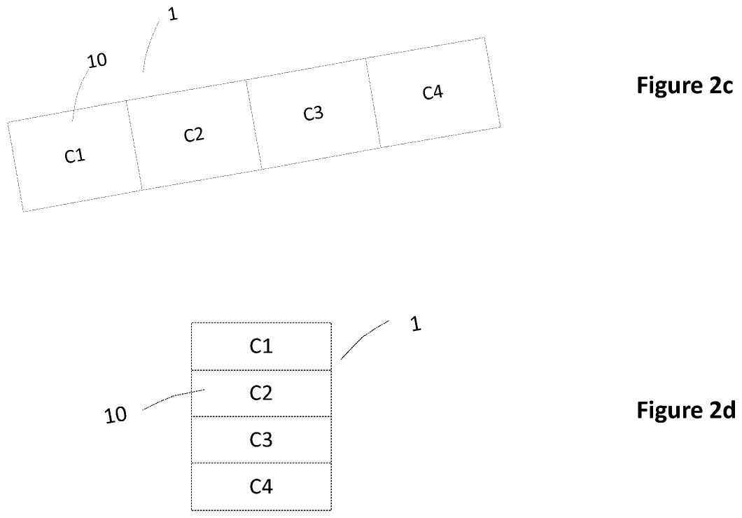

In the embodiments of the present invention, each printhead includes at least two printing units. FIG. 2 uses the first printhead 1 as an example to illustrate four configurations of the printing units. In the example shown in FIG. 2a, the first printhead 1 includes three printing units 10, which are disposed along the direction 11. The first printhead 1 is in fluidic communication with three color inks c1, c2 and c3, and each printing unit 10 is in fluidic communication with one color ink. The c1, c2, and c3 inks can be any color, for example, c1 can be magenta ink, c2 can be cyan ink, and c3 can be yellow ink. FIG. 2b shows the case of four printing units, the four printing units 10 being arranged along the direction 11. The first printhead 1 is in fluidic communications with four color inks c1, c2, c3, and c4, and each printing unit 10 communicates with one color ink. The c1, c2, c3, and c4 inks can be any color, for example, c1 can be magenta ink, c2 can be cyan ink, c3 can be yellow ink, and c4 can be black ink. In the example shown in FIG. 2c, the first printhead 1 includes four printing units 10, where the four printing units are arranged along a direction 13 that is inclined at an angle with respect to direction 11, such that the angle is greater than 0 degrees and less than 90 degrees. The first printhead 1 communicates with four color inks c1, c2, c3, and c4, and each printing unit 10 communicates with one color ink. The c1, c2, c3, and c4 inks can be any color. For example, the c1 can be cyan ink, the c2 can be yellow ink, the c3 can be magenta ink, and the c4 can be black ink. In the example shown in FIG. 2d, the first printhead 1 includes four printing units 10, where the four printing units are arranged along a direction 12 that is perpendicular to the direction 11. The first printhead 1 communicates with four color inks c1, c2, c3, and c4, where each printing unit 10 communicates with one color ink. The c1, c2, c3 and c4 inks can be any color. For example, the c1 can be yellow ink, the c2 can be magenta ink, the c3 can be cyan ink, and the c4 can be black ink. In other embodiments shown in FIG. 2, the first printhead 1 can be in fluidic communication with various functional inks, for example, three printing units are respectively connected to magenta ink, cyan ink and yellow ink, and one printing unit is connected to a color fixative. Using the above four printing unit configurations as examples, this invention also includes other printing unit configurations.

Corresponding printing units in each printhead communicate with the same ink. For example, the printing units in the first printhead 1, the second printhead 2, and the third printhead 3 can all be arranged in the manner shown in FIG. 2a, where the c1 printing unit in the printhead 1 communicates with cyan ink, and the c1 printing units in the second printhead 2 and the third printhead 3 also communicate with cyan ink; the c2 printing unit in the first printhead 1 communicates with magenta ink, and the c2 printing units in the second printhead 2 and the third printhead 3 also communicate with magenta ink; the c3 printing unit in the first printhead 1 communicates with yellow ink, and the c3 printing units in the second printhead 2 and the third printhead 3 also communicate with yellow ink.

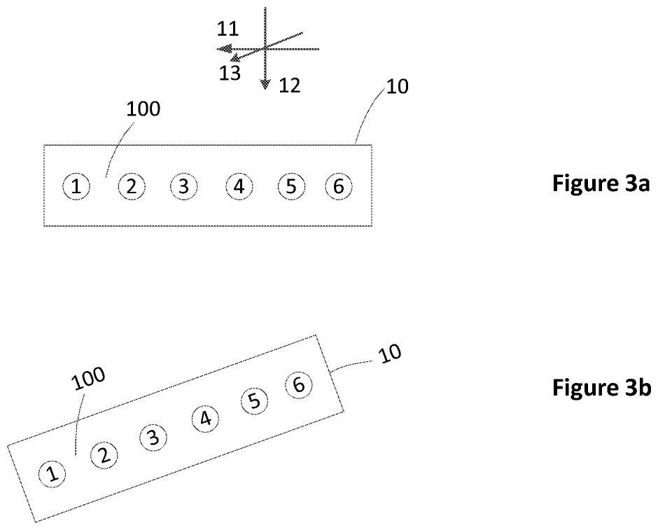

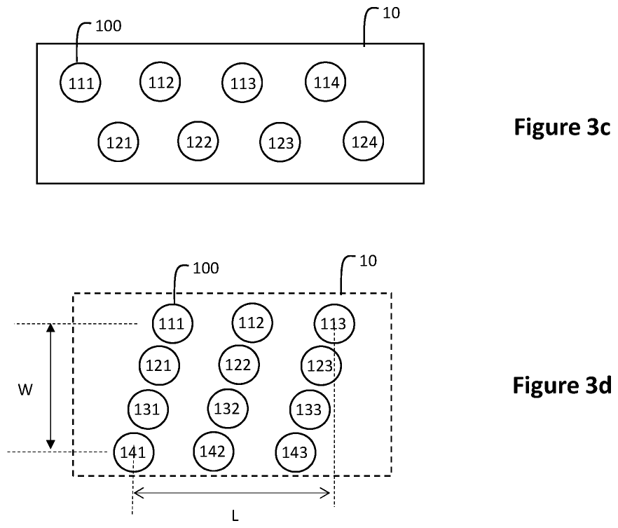

Each printing unit in a printhead includes a plurality of nozzles 100 formed on an orifice plate. FIG. 3 shows four configurations of nozzles. In the example shown in FIG. 3a, the printing unit 10 includes six nozzles 100 marked with 1, 2, 3, 4, 5, and 6, respectively and arranged in a row along the direction 11. The six nozzles are arranged in a row according to their sequential numbers. In the example shown in FIG. 3b, the nozzles are arranged in a row along the direction 13 that is inclined at an angle with respect to the direction 11. In the example shown in FIG. 3c, the printing unit 10 includes two rows of nozzles 100 arranged along the 11 direction. The two rows of nozzles are spaced apart from each other along the direction 12 and are staggered along the direction 11 by half of an adjacent nozzle center-to-center distance. In the example shown in FIG. 3d, the printing unit 10 includes a plurality of nozzles 100 arranged in a two-dimensional array (dotted line enclosed). The length L of the two-dimensional array along the direction 11 is greater than the width W along the direction 12 perpendicular to the direction 11. Each column includes four nozzles, where the nozzles in the first column are marked with 111, 121, 131 and 141, respectively, the nozzles in the second column are marked with 112, 122, 132 and 142, respectively, and the nozzles in the third column are marked with 113, 123, 133 and 143. The nozzles are arranged in four rows along the direction 11, each row including three nozzles, where the nozzles in the first row are respectively marked as 111, 112, and 113, the nozzles in the second row are marked as 121, 122, and 123, the nozzles in the third row are labeled 131, 132 and 133 respectively, and the nozzles in the fourth row are labeled 141, 142 and 143 respectively. The nozzles with the same last digit in their numbers are aligned in a column, and the column direction is inclined with respect to the direction 12. Beyond the four configurations shown above, those skilled in the art can understand that other nozzle arrangements are also applicable to this invention, and the number of nozzles is not limited to the illustrated examples and can be any other number.

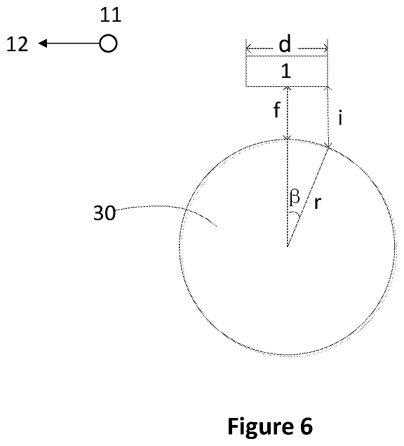

In reference to FIG. 1b, the printing apparatus includes a printing medium 30 disposed opposite to the printheads 1, 2, and 3. The printheads can be on the top with the printing medium 30 below, so that the nozzles of the printheads face the printing medium 30. The printing medium 30 is attached to the drum 20 surface and rotates around the rotational axis G. The cross section of the printing medium 30 in a plane perpendicular to the rotational axis G is circular with the rotational axis G passing through the center of the circle (FIG. 6) and extending in parallel to the direction 11. The printheads are disposed along the direction 11 with the centers of the nozzle array (FIGS. 2 and 3) on the printing units forming a straight line along the direction 11. The straight line through the centers of the nozzle arrays and the rotational axis G are coplanar and define a plane that intersects the curved surfaces of the printing medium 30 at the intersection line Q. The intersection line Q is parallel to the rotational axes G and direction 11, and is also substantially parallel to the orifice plate on each printing unit. The vertical distance (the shortest distance) between the intersection line Q and the orifice plates on the printhead is also called the printing distance that can be controlled and adjusted in a mechanical structure (not shown) that the transporter 50, the guide rail 40, and the drive shaft 60 are mounted to. In the embodiment shown in FIG. 1b, the printing distance along the direction 11 is constant. The constant printing distance ensures uniform printing quality. For a given printhead, usually the shorter the printing distance, the better the print quality. The printing medium 30 is divided, by the number of printheads, into three printing areas along the direction 11, which are labeled as H, J, and K, respectively.

The printing medium 30 is fitted as a sleeve on the drum 20 from the first end 21 to the second end 22 of the drum 20, that is the printing medium 30 is put on the drum 20 starting from the first end 21 and moving toward to the second end 22 until all the printing medium is fitted on the surface of the drum 20. The printing medium 30 can be cylindrical shaped (such as a wine bottle, a metal tube, a plastic tube, a cardboard tube, etc.), or it may not sustain a cylindrical shape in its normal state, for example knitwear (such as socks, pants, some garment materials) and flexible materials (such as textiles, plastic films, paper or leather), but it can be conformally fit on to or wrapped around the surface of the drum 20. The preferred size of the drum 20 is determined by the size of the printing medium 30, which ensures no slippage of printing medium on the drum, and has a sufficient surface to allow the flexible materials to cover the surface of the drum without overlapping or being irreversibly deformed. A hard cylindrical medium can be fitted as a sleeve on a suitable drum 20, or it can be directly mounted on other rotational mechanisms without using a drum. The rotational axes of the other rotational mechanisms and the drum 20 coincide with the rotational axis G. The length of the printing medium 30 along the direction 11 is m. In general, the length of the drum 20 along the axial direction is greater than m. At the beginning of printing, the distance between the nozzle closest to the first end (for example, nozzle 1 in FIG. 3a) of the first printhead 1 and the first end 21 of drum 20 along the direction 11 is a. The printing medium 30 is divided into equal sized areas according to the number of printheads, marked as H, J, and K with equal length of c along the first direction 11. The printheads are identical and evenly spaced with pitch of b. This pitch is also the distance between corresponding nozzles (having same relative positions in the respective printheads) in adjacent printheads. For example, combining configurations in FIGS. 2c and 3d, each printhead has four printing units, and each printing unit has a two-dimensional array of nozzles. The distance between the first printhead 1 and the second printhead 2 is equal to the distance between the nozzle 121 in the c1 printing unit of first printhead 1 and the nozzle 121 in the c1 printing unit of the second printhead 2 along the first direction (also direction 11), and is also equal to the distance between nozzle 132 in the c2 printing unit of the first printhead 1 and nozzle 132 in the c2 printing unit of the second printhead 2 along the first direction 11. Similarly, the distance between the second printhead 2 and the third printhead 3 is the equal to the distance between the corresponding nozzles of the adjacent printheads. The distance between all the adjacent printheads herein is referring to the distance between the corresponding nozzles of the adjacent printheads. In the embodiment shown in FIG. 1b, the length m of printing medium 30 equals the distance a between the nozzle closest to the first end of the first printhead 1 and the opposite first end 21 of the drum 20. Also in the FIG. 1b embodiment the printhead pitch b equals the length c of the equally sized printing areas of printing medium 30. In other words, m=a and b=c. When the medium length m is changed, the distance between the printheads can be adjusted so that m=a, b=c=m/n, where n is the number of printheads.

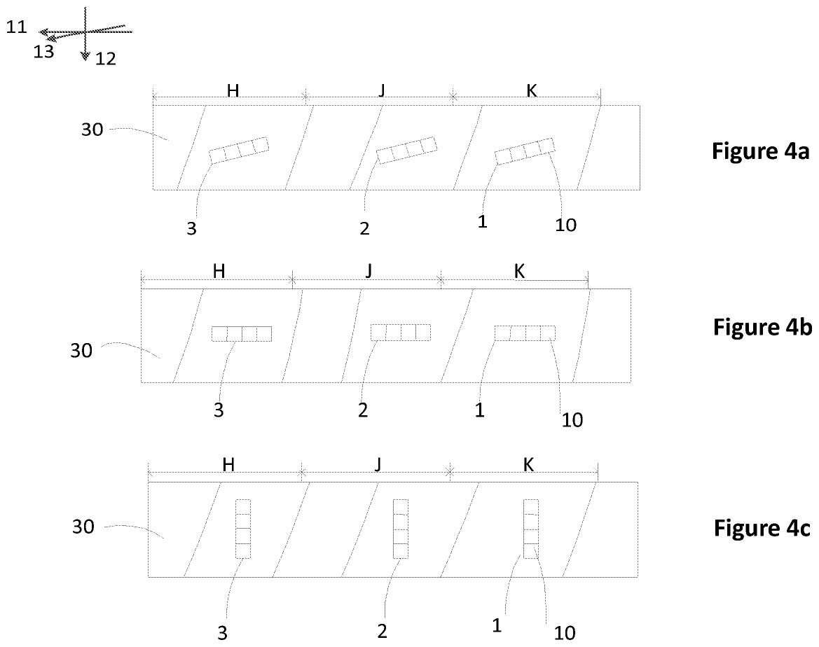

FIG. 4 is a top view of the printing apparatus. In order to more clearly display the positional relationship between the printhead and the printing medium, the transporter, the connections between the transporter and the printheads, and the mountings are omitted. In reference to the example shown in FIG. 4a, the first printhead 1, the second printhead 2, and the third printhead 3 are arranged along the direction 11. The printing units 10 in each printhead are arranged along the direction 13. The printing medium 30 is divided into three printing areas H, J, and K along the direction 11 (which is the same direction as the rotational axis G). In the example shown in FIG. 4b, the first printhead 1, the second printhead 2, and the third printhead 3 are arranged along the direction 11. The printing units 10 in each printhead are arranged along the direction 11. The printing medium 30 is divided into three printing areas H, J, and K along the direction 11. In the example shown in FIG. 4c, the first printhead 1, the second printhead 2 and the third printhead 3 are arranged along the direction 11. The printing units 10 in each printhead are arranged along the direction 12. The printing medium 30 is divided into three printing areas H, J, and K along the direction 11. The above embodiments show three cases of positional relationship between the printheads and the printing medium. Those skilled in the art will understand that the arrangement of the printing units can be arranged in other ways, as long as the arrangement direction of the printhead is parallel to the rotational axis G of the printing medium 30.

When the printing apparatus is printing, the printing medium 30 continuously rotates around the rotational axis G at a uniform angular speed, and at the same time, each printhead is printing and advancing synchronously in the direction 11 at a constant speed. The motion direction of the printheads is parallel to the direction of the rotational axis G to ensure that the printheads keep a constant distance to the printing medium 30 during the motion and not deviating away from the printing medium. In multi-color printing, each printing unit communicates with one color ink. When the printing medium 30 completes one full rotation, the printheads advance a distance equal to the length of one printing unit in a printhead along the direction 11. Each printing area is printed by one printhead, for example, the first printhead 1 is responsible for printing the K area, the second printhead 2 is responsible for printing the J area, and the third printhead 3 is responsible for printing the H area. In addition, in the embodiment described above with reference to FIG. 1b where m=a, b=c=m/n, since the distances b between printheads are equal to their respective printing area lengths c and the printing area lengths are also equal to each other, each printhead starts printing at the same time and finishes printing at the same time. After printing the entire printing area is completed, the relative distance moved along direction 11 between the printheads and the printing medium 30 is equal to the length of the single printhead plus the length of the printing area c=b along direction 11. Therefore, the larger the number of printheads (n), the smaller the pitch b between adjacent printheads, the smaller the length c=b of corresponding printing area, and the faster the speed of printing a piece. The length of a printhead refers to the distance between the two furthest nozzles in a printhead along the direction 11. Taking the first printhead 1 as an example, with reference to FIGS. 2c and 3c configuration, the length of the printhead 1 is equal to the distance between the nozzle 111 in the c1 printing unit and the nozzle 124 in the c4 printing unit in the first printhead 1 along the first direction 11. The length of any printhead needs to be less than the length of the printing area, preferably less than half the length of the printing area. In addition, the length of the printing unit refers to the distance of the two furthest nozzles in a printing unit along the direction 11. Taking the c1 printing unit as an example with nozzle configuration shown in FIG. 3c, the length of the printing unit is the distance from nozzle 111 to the nozzle 124 along the first direction. The length of the printing unit is less than m/n and is also less than or equal to the length of the printhead divided by the number of printing units.

In another embodiment, the distances between adjacent printheads may not be equal. It can be designed that the distance difference between any two pairs of adjacent printheads does not exceed 50% of the distance between any pair of adjacent printheads. For example, the distance difference between the first printhead 1 and the second printhead 2 and between the second printhead 2 and the third printhead 3 does not exceed 50% of the distance of the first printhead 1 and the second printhead 2, or the distance of the second printhead 2 and the third printhead 3. The length difference of any two printing areas, H/J/K, does not exceed 50% of the length of any printing area. If the distance between the first printhead 1 and the second printhead 2 is equal to the length of the printing area K, the distance between the second printhead 2 and the third printhead 3 is equal to the length of the printing area J, the distance of the third printhead 3 to the first end 21 along the direction 11 is equal to the length of the printing area H, but K≠J≠H. In this case, it is also possible that three printheads start printing at the same time, but the three printheads do not finish printing at the same time. The printing time depends on the maximum distance between adjacent printheads, which also corresponds to the maximum printing area length. To print the same media, setting the printheads with non-equal distances takes longer time to print a part than for equal distances. Also the usages on the printheads are uneven.

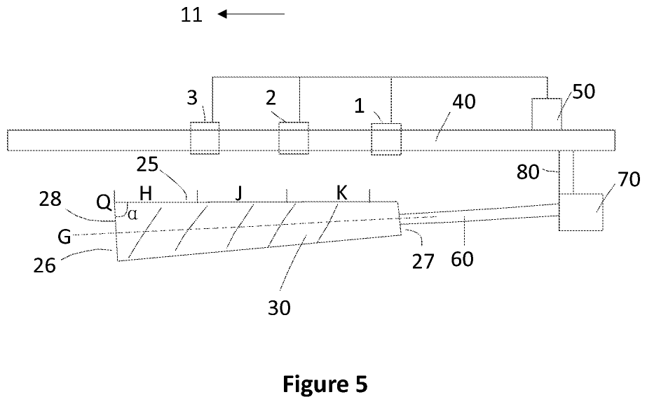

FIG. 5 shows a configuration where the printing medium 30 has a conical frustum shape. It can be a frustum in its natural form such as a paper cup, or a flexible material with the dimensions of the curved surface of a frustum and conforming to the surface to take on the frustum shape when wrapped onto a frustum. For example, the printing medium can be knitwear (such as socks, pants, or other garment parts) and flexible materials (such as cloth, plastic film, paper, or leather). The axis of the conical frustum 25 is G (dashed line in FIG. 5). Conical frustum 25 has a first end 26 having a diameter that is larger than that of the opposing end 27. When the conical frustum rotates around the axis, the printing medium 30 is driven to rotate around the rotational axis G. The cross sections of the printing medium 30 in a plane perpendicular to the rotation axis G are circular shapes with the rotational axis G passing through the center of the circle. Although these cross sections of the conical frustum are circular shapes, the diameters of the cross sections are different at different axis points. If the embodiment shown in FIG. 1b is used, in which the axis G of cylindrical drum is coplanar with and parallel to direction 11, the intersection line Q of the surface of conical frustum is inclined with respect to the direction 11. In other words, the distance between the printing medium 30 and the printheads changes along the direction 11 (one end is closer to the printhead, and the other end is farther away from the printhead). That means the printing distance changes along the direction 11, consequently causing a change in the ink drop placement position and resulting in uneven print quality and gradual distortion of the image. In order to solve this problem, the rotation axis G in FIG. 5 is inclined relative to the 11 direction in the same plane, and the inclined angle is equal to 90°-α, where α is the included angle between a line 28 that is in the plane of the first end 26 and perpendicular to the rotational axis G of the conical frustum 25. After the rotational axis G is inclined, the intersection line Q becomes parallel to the direction 11, so the printing distance is substantially constant along the direction 11. The printing medium 30 is also divided into three printing areas along the direction 11. Each printhead prints one printing area. The transporter 50 is connected to the first printhead 1, the second printhead 2, and the third printhead 3 respectively and controls the printhead linear motion along the guide rail 40. The motor 70 drives the drive shaft 60 to rotate, in turn, the drive shaft 60 rotates the frustum drum 25 and controls the printing medium 30 to rotate around the G axis. The other features in FIG. 5 can be the same as those described in FIGS. 1-4.

The embodiment described above solves the problem of the distance change along the direction 11 between a conically shaped printing medium 30 and the printheads. In the direction perpendicular to the plane formed by the axis G and the direction 11, that is also the width direction of the printhead (the direction 12 in FIG. 3), the distance between the nozzles in the printheads and the printing medium varies along the printhead width direction (direction 12) as shown in FIG. 6 for some printheads (such as printheads with two-dimensional nozzle arrays), because those printheads extend along a width direction and the surface of the printing medium curves in the width direction. Taking the first printhead 1 as an example, the distances of ink droplets ejected from nozzles at different positions along the direction 12 to the corresponding positions on the printing media are different. The shortest distance is at the center of the nozzle array, the furthest distance is at the two width ends. If the radius r of the drum cannot be much larger than the width d of the printhead (r/d>>1), the distance variation between the nozzles and the printing medium cannot be ignored. The narrower the printhead width (equal to the distance between the endmost nozzles of the printhead along direction 12), closer to satisfying r/d>>1, the better for printing quality. However, if the printhead width is too narrow, it will significantly affect the printing speed and resolution. Therefore, it is necessary to find the maximum width of the printheads with acceptable print quality. Assume that the acceptable distance between the endmost nozzles of the first printhead 1 and the printing medium 30 is i, and that beyond this distance, the printing quality will become objectionable. The distance between the nozzle at the middle of the first printhead 1 and the printing medium is f. The radius of the printing medium 30 is r. The angle β can be solved from the equation cos β=1−(i-f)/r. The width of the first printhead is d=2r*sin β. If the width of the first printhead 1 is not greater than the calculated d, the print quality can meet the requirements.

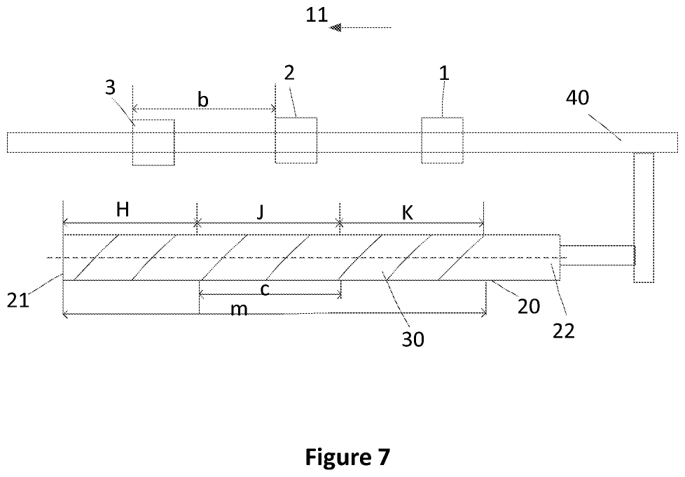

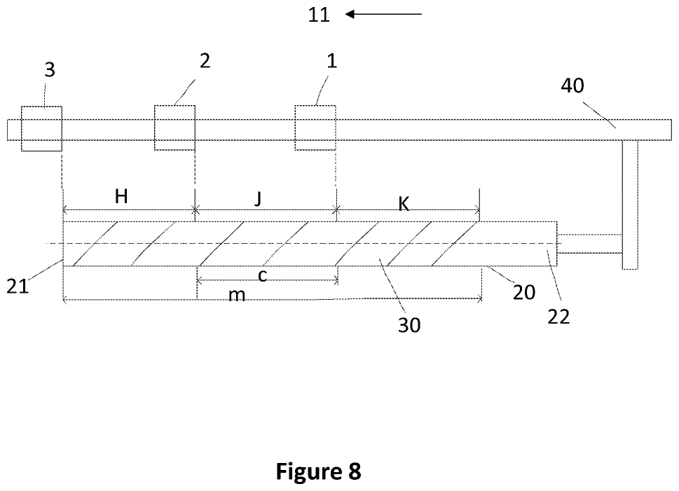

When the printing apparatus shown in FIG. 1b prints, all the printheads move synchronously and start printing after entering their respective printing areas. FIG. 7 shows a snapshot during printing when the first printhead 1 is printing area H, the second printhead 2 is printing area J, and the third printhead 3 is printing area H. FIG. 8 shows the state at the end of printing. After each printhead finishes printing its own area, it leaves the corresponding area and completes one pass. If the same printing apparatus is used to print a higher resolution and/or a higher ink coverage, the printheads can return to the starting positions and repeat the printing process of FIGS. 1b, 7, and 8. This printing process can be repeated multiple times, also known as multiple pass (the number of times the printheads pass over the surface of the printing medium) printing. For multi-color printing (one printhead prints two colors or more), after each complete rotation of the printing medium, the relative displacement of the printhead and the printing medium along the first direction is equal to e/k, where e is the length of a printing unit in the first direction, and k is the number of passes and is a positive integer greater than or equal to 1. For monochrome printing, after each complete rotation of the printing medium 30, the relative displacement of the printhead and the printing medium in the first direction is equal to the length of a printhead in the first direction divided by k, where k (the number of passes) is a positive integer greater than or equal to 1. For clarity, the transport, the connection mechanism between the transport, the printheads, and the motor are not shown in FIGS. 7 and 8. The following figures also omit those parts. It is understood that this will not hinder the understanding of this invention by those skilled in the art.

In practical applications, the distance b between the printheads and the length m of the printing medium 30 may not be optimized and matched as shown above in FIG. 1b and FIGS. 7-8. FIGS. 9-1 to 9-6 show the printing process when the distance b between adjacent printheads is greater than the length c of the printing area.

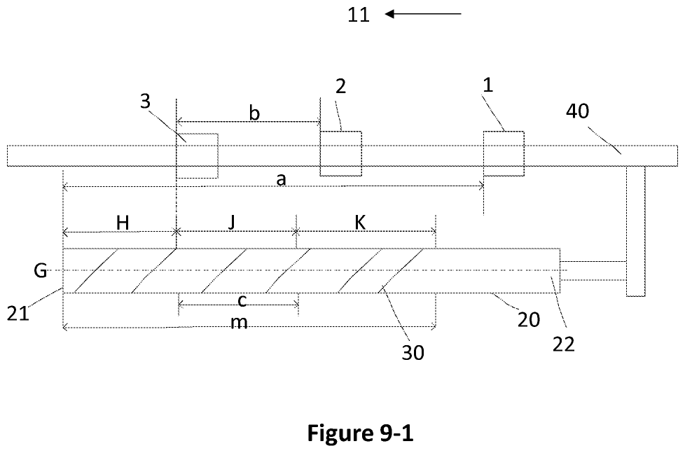

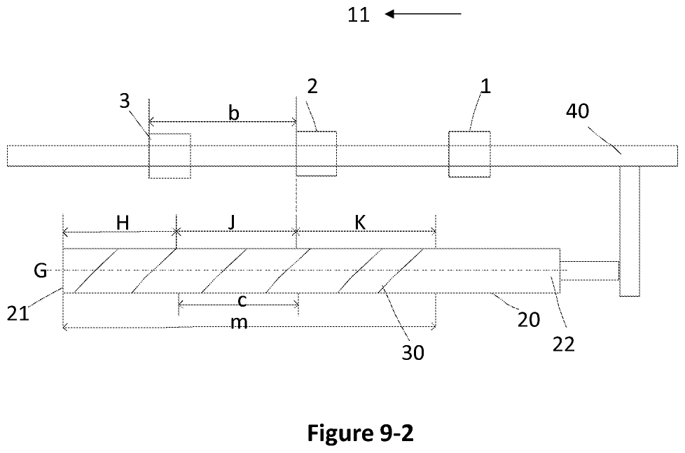

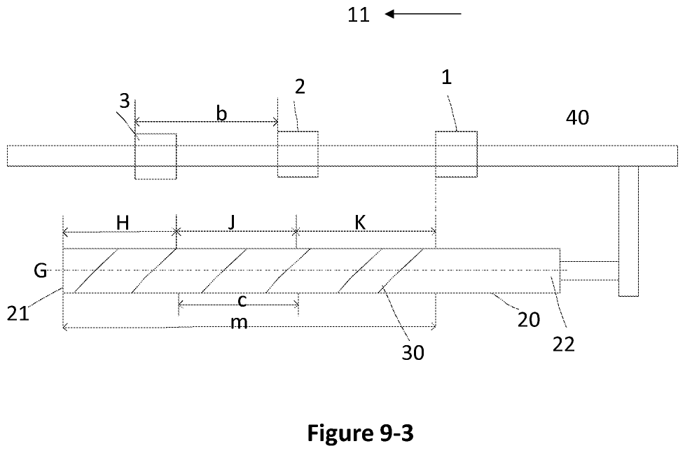

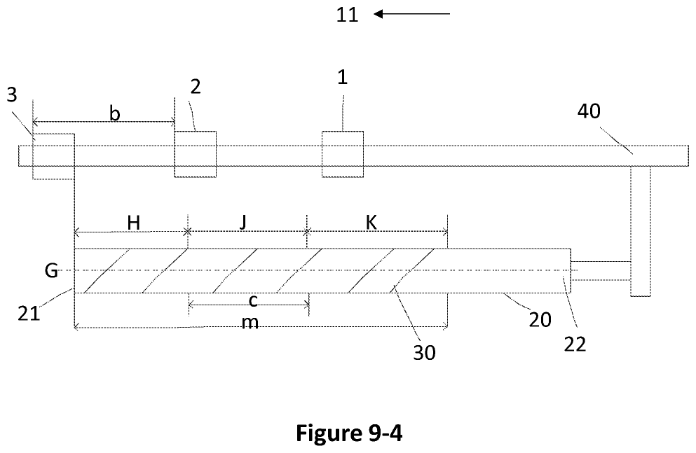

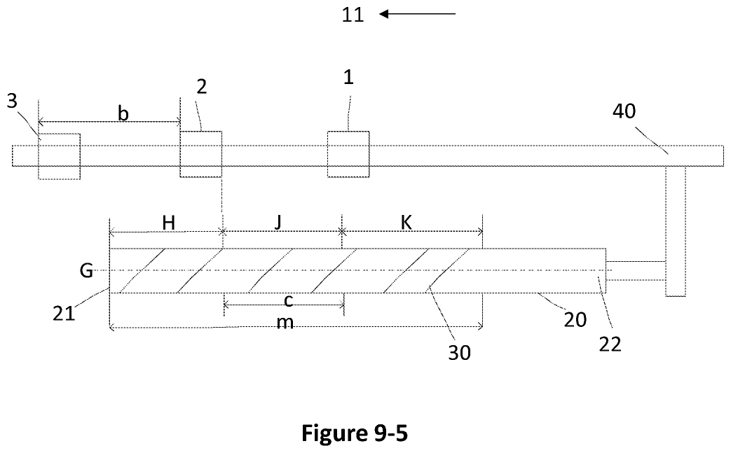

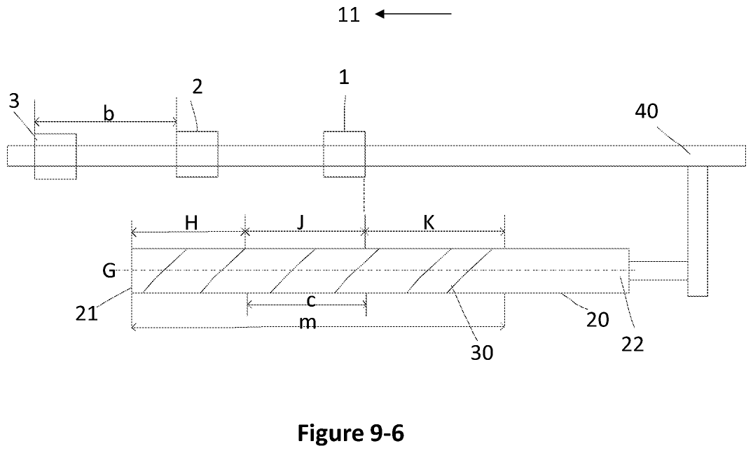

Specifically, as shown in FIG. 9-1, the lengths of the printing areas are equal (c=m/n), and the printheads are arranged at an equal distance of b, where b>c and each printhead is responsible for printing its corresponding area. So the third printhead 3 should be closest to the beginning of the area H at the start of printing. Determined by the distance b between adjacent printheads and the length c of the printing area, the second printhead 2 is farther away from the area J, and the first printhead 1 is the farthest away from the area K. As a result, the distance a between the nozzle closest to the first end of the printhead and the opposite first end 21 of the drum is greater than m (a>m). During printing, the third printhead 3 enters the area H first and starts printing while the other printheads advance toward their respective printing areas without printing. The printheads continue to advance. As shown in FIG. 9-2, the second printhead 2 enters the area J and starts printing. At this time, the third printhead 3 has printed a partial area, and the first printhead 1 has not yet entered the area K. The printheads continue to advance in the direction 11. As shown in FIG. 9-3, the first printhead 1 enters the area K and starts printing. At this time, the second printhead 2 and the third printhead 3 are both in the printing process. The printheads continue to move forward. As shown in FIG. 9-4, the third printhead 3 completes printing. At this time, the second printhead 2 and the first printhead 1 are both in the printing process. The printheads continue to move forward to a state shown in FIG. 9-5, when the second printhead 2 completes printing, and only the first printhead 1 is still printing the area K. The printheads continue to advance to a state shown in FIG. 9-6, when the first printhead 1 completes printing, and both the second printhead 2 and the third printhead 3 have previously finished printing. At this time the printing job on this printing part is completed. In the embodiment shown in FIGS. 9-1 to 9-6, the printhead 3 that started printing first would end printing first, and the printheads 1 and 2 that started printing later would end printing later. Each printhead has a different printing start time and a different printing end time. Compared with the embodiment where the positions of the printhead are adjusted so that b=c and m=a (shown in FIG. 1b), the overall printing time in the FIG. 9 embodiment is longer.

Similarly, FIGS. 10-1 to 10-6 show the printing process when b is less than c.

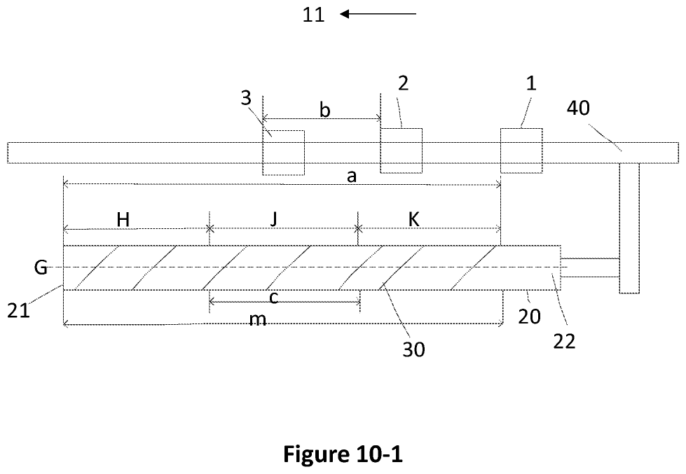

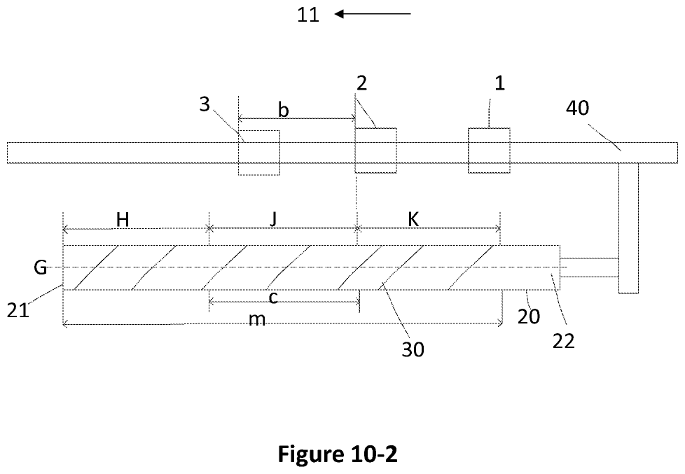

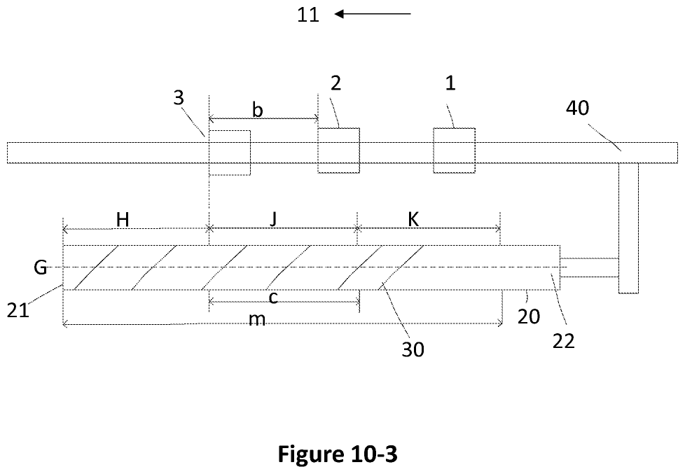

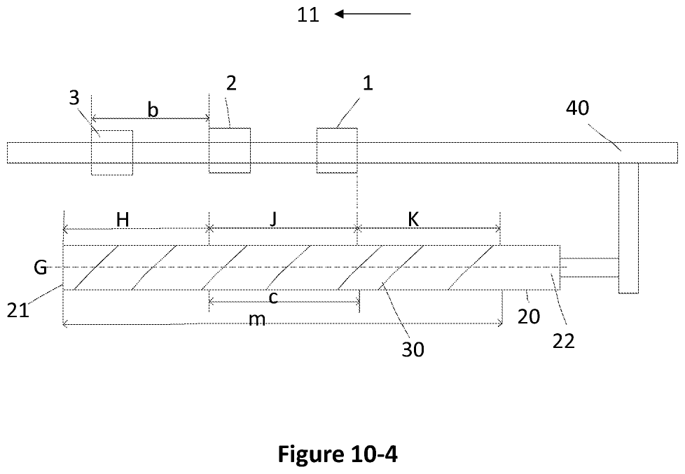

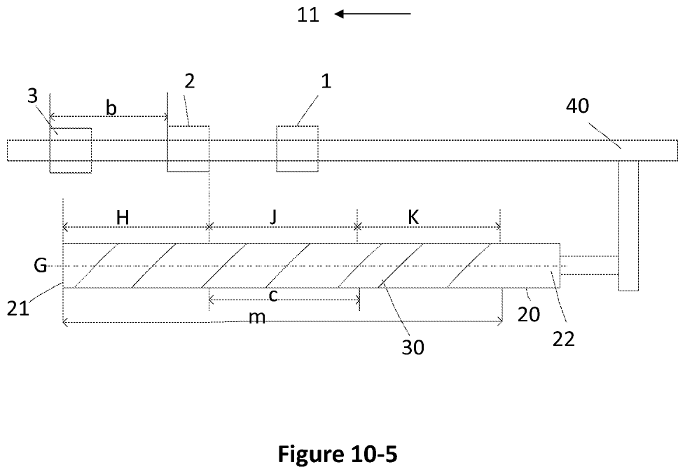

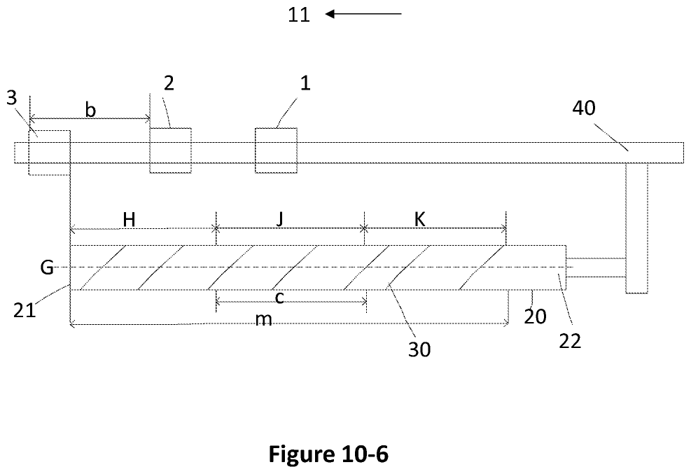

Specifically, as shown in FIG. 10-1, the lengths c of the printing areas are all equal to m/n (c=m/n). The printheads are arranged at an equal distance of b. At the printing start position, the first printhead 1 should be the closest to the beginning of the area K, while the second printhead 2 is farther away from the area J, and the third printhead 3 is the farthest away from the area H. During printing, the first printhead 1 enters the area H first and starts printing, while the other printheads advance toward their respective printing areas without printing. The printheads continue to advance to a state as shown in FIG. 10-2, when the second printhead 2 enters the area J and starts printing. At this time, the first printhead 1 has printed part of area K and continues printing, and the third printhead 3 has not entered the area H. The printheads continue advancing in the direction 11 to a state shown in FIG. 10-3, when the third printhead 3 enters the area H and starts printing, at this time the second printhead 2 and the first printhead 1 are also in the printing process. The printheads continue advancing to a state shown in FIG. 10-4, when the first printhead 1 finishes printing the area K, and at this time, the second printhead 2 and the third printhead 3 are both in the printing process. The printheads continue moving forward to positions shown in FIG. 10-5, where the second printhead 2 completes printing, and only the third printhead 3 is still printing the area H. The printheads continue advancing to a state shown in FIG. 10-6, when the third printhead 3 completes printing, and both the second printhead 2 and the first printhead 1 have finished printing before this time. The printing job on this printing part is completed. As shown in FIGS. 10-1 to 10-6, the printhead that started printing first completes printing first, and printheads that started printing later would end printing later. Each printhead starts printing at different times, and also completes printing at different times. The overall printing time for a part is longer relative to the optimized configuration shown in FIGS. 1b, 7 and 8.

In the printing process of the embodiment shown in FIGS. 9-10 above, the distance between the adjacent printheads can be unequal, but the variation is preferred not to exceed 50%. The optimal configuration is where the distances between printheads are uniform. The lengths of the printing areas can also be unequal, but the variation is preferred not to exceed 50%. The optimal configuration is where the printing areas have equal length. Under other combinations of different printhead distances and different printing area lengths, the printhead start and complete sequences can be different from those shown in FIG. 9-10, but the process should be similar. Each printhead has a different start time and a different complete time. Compared with the optimized configuration shown in FIGS. 1b, 7 and 8, the overall printing time is longer.

FIGS. 11-1 to 11-3 show an embodiment where the printing apparatus includes two printheads with distance b between the first printhead and the second printhead. The printing medium is divided into 3 areas where the lengths of the areas J and K are both c. The length of the area H can be less than or equal to c, where c and b are substantially equal.

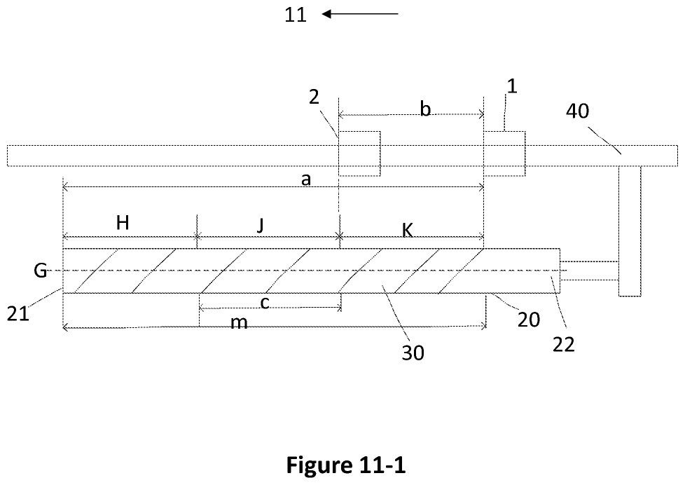

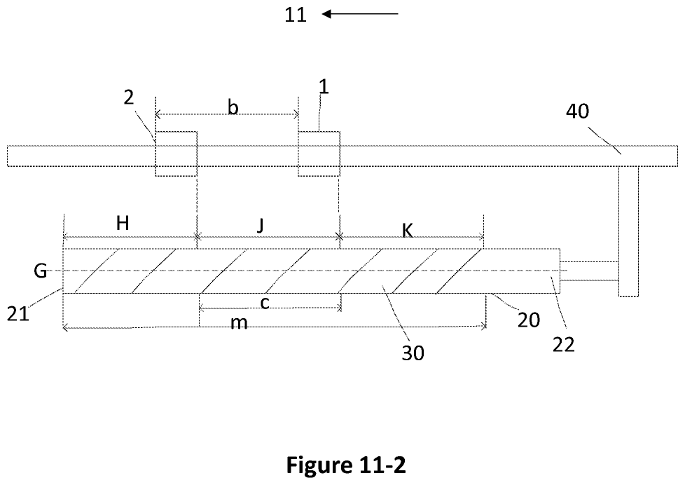

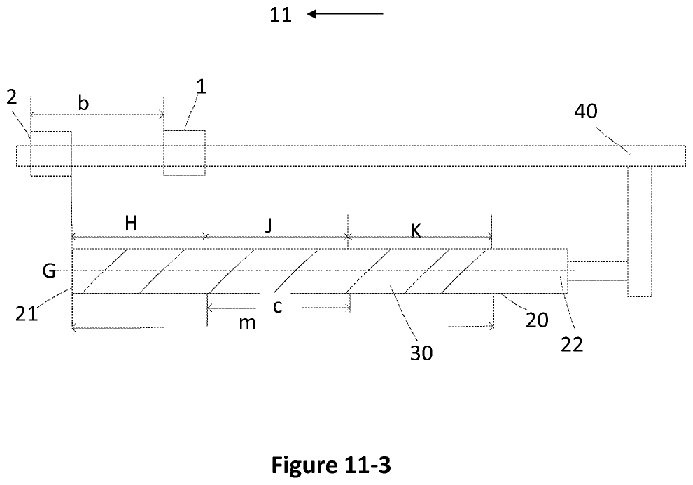

At the start shown in FIG. 11-1, the first printhead 1 and the second printhead 2 move synchronously in the direction 11 and start printing at the same time. As the first printhead 1 completes printing the area K, the second printhead 2 also completes printing the area J (shown in FIG. 11-2). Afterwards, the first printhead 1 and the second printhead 2 continue moving in the direction 11, but the first printhead is not printing while the second printhead prints the printing area H, until the second printhead 2 finishes printing the area H. Then the printing job on the printing medium 30 is completed (FIG. 11-3).

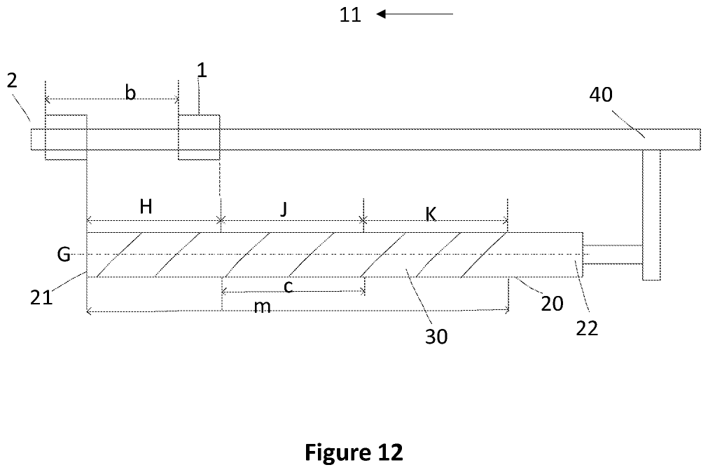

After the above printing job is completed, the printheads can print during moving in reverse direction, that is, the printheads move in the reverse direction of the direction 11. At the start, the first printhead 1 and the second printhead 2 are located at the positions shown in FIG. 12, where the first printhead 1 prints the printing areas J and K, and the second printhead 2 prints the printing area H. The printing process is similar to the method shown in FIGS. 11-1 to 11-3, but in the reverse direction.

In the embodiments shown in FIGS. 13-1 to 13-2, the length m of the printing medium is less than n*b, and the printing apparatus includes three printheads with distance b between the second printhead 2 and the third printhead 3. The printing medium 30 is divided into two printing areas, such that the lengths of the printing area H and the printing area J are both c, and c=b.

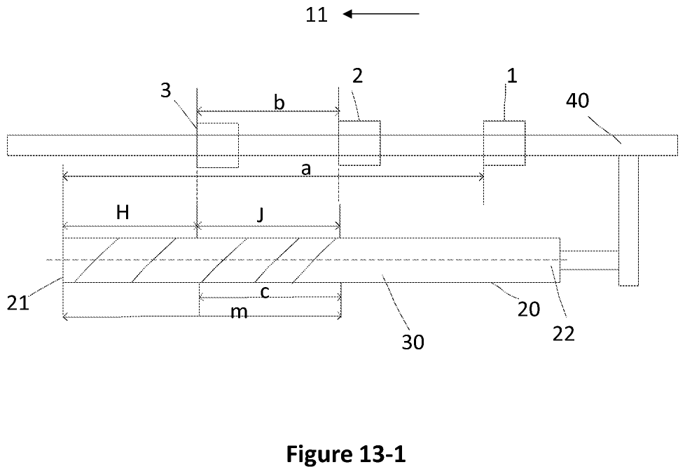

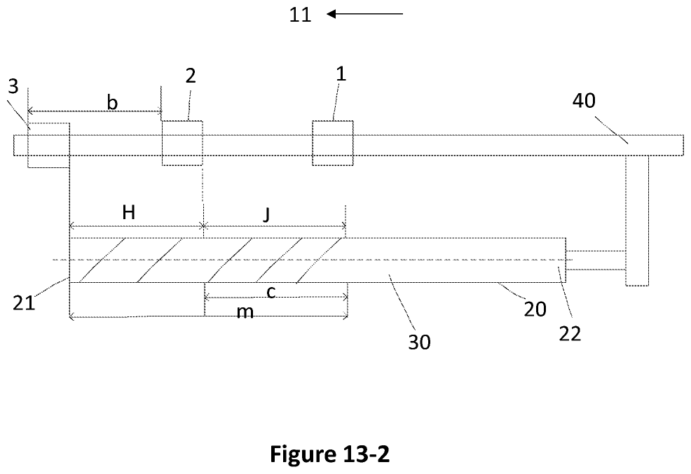

At the start shown in FIG. 13-1, all printheads move in the direction 11 simultaneously. The second printhead 2 and the third printhead 3 start printing at the same time. The third printhead prints the printing area H, the second printhead prints the printing area J, and the first printhead 1 does not print. As shown in FIG. 13-2, the third printhead 3 and the second printhead 2 complete printing the printing areas H and J, respectively. The first printhead 1 does not print during this printing process.

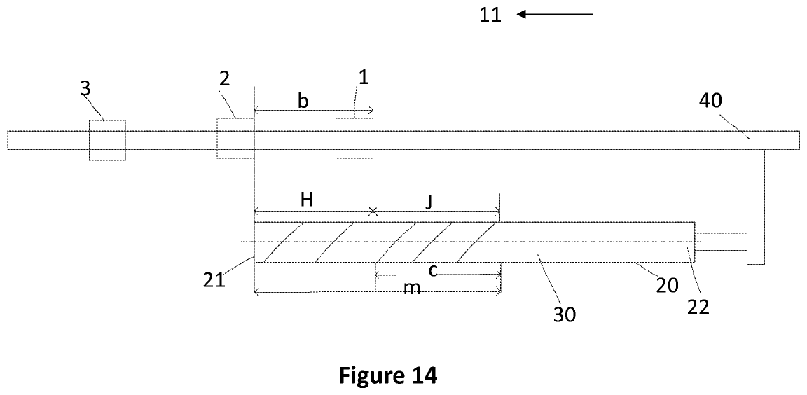

If the printhead 1 has not been used for a long time, it will affect its jetting performance and need maintenance, resulting in wasted ink. To avoid that, after multiple prints, the printing method shown in FIG. 14 can be utilized where the first printhead 1 and the second printhead 2 are a distance b apart, and b=c. The printheads move in a direction opposite to the direction 11. The first printhead 1 prints the printing area J, the second printhead 2 prints the printing area H, and the third printhead 3 does not print.

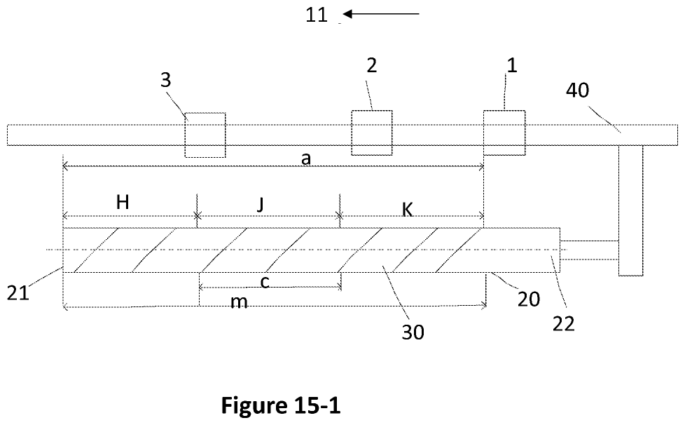

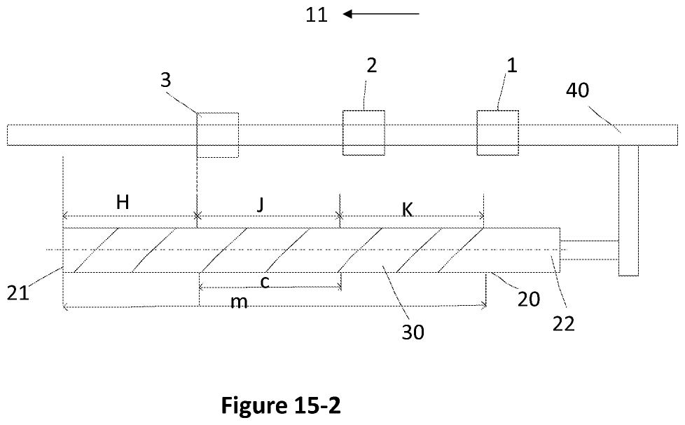

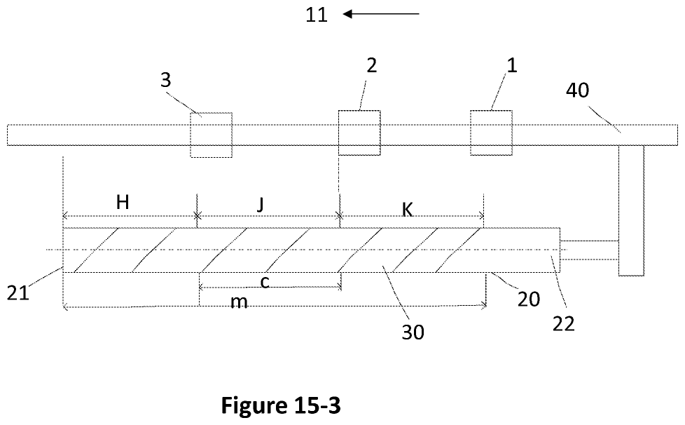

In some embodiments the printheads can not only move synchronously, but also each printhead can move independently shown in FIGS. 15-1 to 15-3. In FIG. 15-1, the first printhead 1 is aligned to the edge of the area K while the second printhead 2 has not yet entered the printing area J, and the third printhead 3 is in the printing area H. Before printing starts, the third printhead is moved from the position shown in FIG. 15-1 to the position shown in FIG. 15-2, and the second printhead 2 is moved from the position shown in FIG. 15-1 to the position shown in FIG. 15-3. The result is that the configuration is changed to the embodiment shown in FIG. 1b. In addition, the printheads can be moved according to the length m of the printing medium, so that the printhead distance b is equal to m/n (b=m/n), and the length c of each printing area is equal to printhead distance (c=b), forming the configuration shown in the FIG. 1b embodiment. Furthermore, the speeds of the printheads can also be different. For example, the resolutions required in different printing areas on the printing medium can be different, or some printing areas need to be left blank. For areas requiring lower resolution or including white space, the printheads scan over the area quickly. The printheads scan slowly in the areas that require higher resolution.

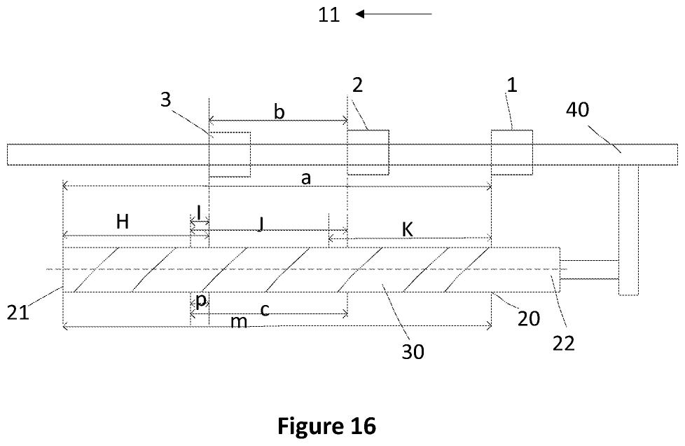

As shown in FIG. 16, the printing areas can overlap. The printing area H and the printing area J overlap in area I. The length of the I area is p, where p does not exceed 20% of the length of any printing areas H, J, or K. The overlapping area I is printed jointly by the first printhead 1 and the second printhead 2, meaning part of the dots in the overlapping area I are printed by the first printhead 1, and the remaining dots are printed by the second printhead 2. Having the overlapping area I can enable feathering to blend the boundary between the printing area H and the printing area J to be less abrupt and improve the printing quality. For printing in other overlapping areas, the same printing method as described above can be used, which will not be described here.

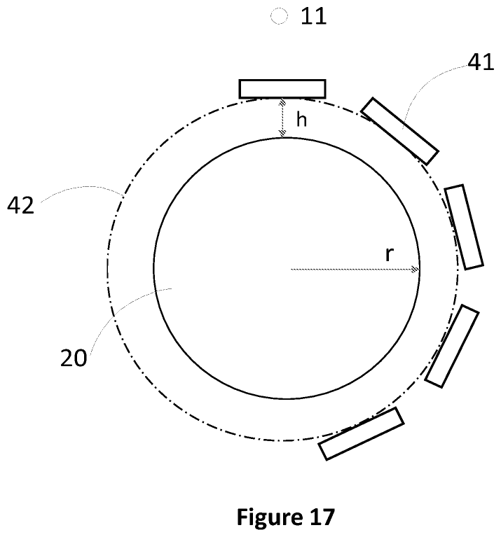

The embodiments described above in FIGS. 1-16 include only one row of printheads. FIG. 17 shows a cross section of an embodiment including multiple rows of printheads. The cross section is perpendicular to rotational axis G. In a multi-row printhead configuration, each printhead is similar to the printheads described in previous embodiments. The printheads in each row 41 are aligned along the direction 11 that each row extends. Printhead rows 41 are parallel to each other and have identical shortest vertical distance h to the surface of the drum 20, and are arranged along tangential lines of the cylindrical surface 42 at a distance h from the surface of the cylindrical drum 20. The printhead rows can be staggered or aligned to increase the print resolution or print speed.

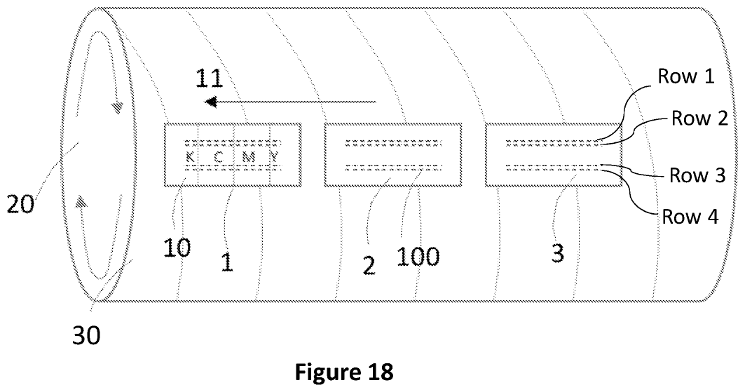

FIG. 18 shows a printing apparatus in which the drum 20 rotates in the direction indicated by the arrow. The printing medium 30 is wrapped on the surface of the drum 20. The three printheads 1, 2, and 3 are arranged along the direction 11. Each printhead includes four printing units 10, which are disposed along the direction 11. The nozzles in each printing unit 10 are disposed in four rows along the direction 11. From left to right, the four printing units 10 jet black (K), cyan (C), magenta (M), and yellow (Y) inks (the order of ink positions can be interchanged). In a printing unit, the first row (Row 1) of nozzles is paired and aligned with the fourth row (Row 4) of nozzles, and the second row (Row 2) of nozzles is paired and aligned with the third row (Row 3) of nozzles, since the distances of two corresponding nozzles to the surface of the printing medium 30 are the same. Each color printing unit has multi-nozzle arrays design, which can increase printing speed or provide nozzle redundancies to improve printhead life. Only the color structure of the first printhead 1 is shown in the figure. The second printhead 2 and the third printhead 3 can have the same structure, but for simplicity, the color order is not shown for them. It is understood that this will not hinder the understanding of those skilled in the art.

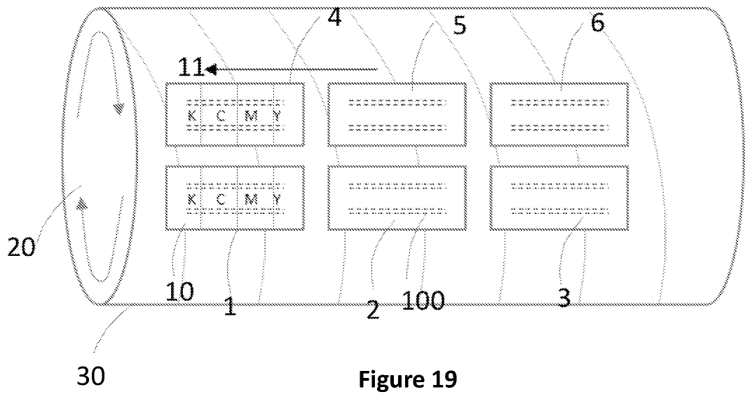

FIG. 19 shows an embodiment of another printing apparatus. The difference from FIG. 18 is that the printheads are arranged in two rows along the direction 11, such that the printheads 1, 2 and 3 are in one row and the printheads 4, 5 and 6 are in another row. The printheads in the two rows are aligned in a way that the first printhead 1 and the fourth printhead 4 are identical and symmetrically arranged with respect to the rotational axis, the second printhead 2 and the fifth printhead 5 are identical and symmetrically arranged, and the third printhead 3 and the sixth printhead 6 are identical and symmetrically arranged. All printheads can have the same color order structure as shown in the first printhead 1. In each printhead, the first nozzle row is symmetrical to the fourth nozzle row of the opposing printhead, the second nozzle row is symmetrical to the third nozzle row of the opposing printhead, and the third nozzle row is symmetrical to the second nozzle row of the opposing printhead, and the fourth row of the nozzles is symmetrical to the first nozzle row of the opposing printhead. The two corresponding nozzles on the opposing printheads have a constant distance to the surface of the printing medium 30. Using multiple rows of printheads can increase the printing resolution and speed. The figure only shows the color structure of the first printhead 1 and the fourth printhead 4, other printheads can also have the same structure, but are not shown in the figure for simplicity. It is understood that this will not hinder the understanding of those skilled in the art.

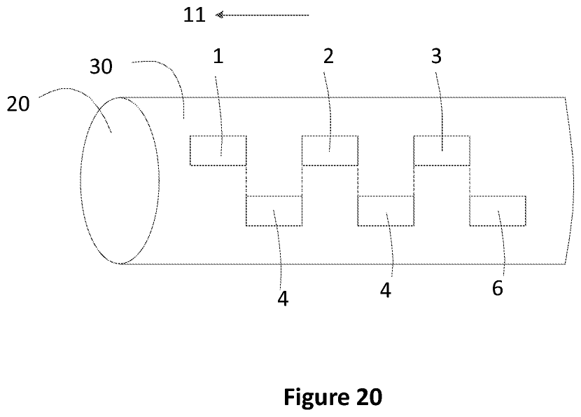

FIG. 20 shows a printing apparatus different from FIG. 19, in which the printheads are arranged in two rows along the direction 11. The printheads 1, 2 and 3 are in one row and the printheads 4, 5 and 6 are in another row. The printheads in the two rows are staggered. The fourth printhead 4 is substantially aligned with the gap between the first printhead 1 and the second printhead 2. The fifth printhead 5 is substantially aligned with the gap between the second printhead 2 and the third printhead 3. Similarly, the second printhead 2 is substantially aligned with the gap between the fourth printhead 4 and the fifth printhead 5, and the third printhead 3 is substantially aligned with the gap between the fifth printhead 5 and the sixth printhead 6. The term substantially aligned means best fit of printheads and corresponding gaps that have substantially equal length along the direction 11. The printheads can be slightly longer or shorter than the gap. The printhead configuration can be any of the configurations described above. During printing, the drum 20 rotates, and each printhead moves back and forth along the direction 11. Since the gaps between the printheads in the same row are aligned with the printheads in the other row, each printhead only needs to move a printhead width, without having to move a printhead width plus the distance between the printheads. So the printing efficiency is greatly improved.

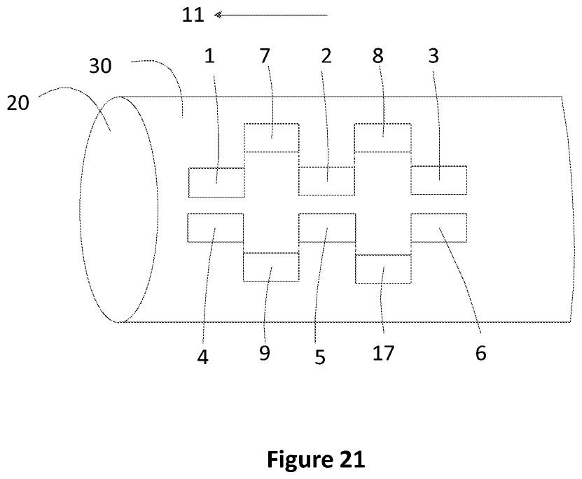

FIG. 21 shows another printing apparatus. It differs from FIG. 20, having printheads arranged in four rows along the direction 11. The printheads 1, 2 and 3 are in the first row, the printheads 4, 5 and 6 are in the second row, the printheads 7 and 8 are in the third row, and the printheads 9 and 17 are in the fourth row. The first and second rows are in the middle, and the third and fourth rows are on outer sides. The printheads of the first and second rows are aligned with each other, and the printheads of the third and fourth rows are aligned with each other. The printheads of the first and third rows are staggered, and the printheads of the second and fourth rows are staggered. Specifically, the seventh printhead 7 is substantially aligned to the gap between the first printhead 1 and the second printhead 2, the eighth printhead 8 is substantially aligned to the gap between the second printhead 2 and the third printhead 3, and the second printhead 2 is substantially aligned to the gap between the seventh printhead 7 and the eighth printhead 8. The gap between the fourth printhead 4 and the fifth printhead 5 is substantially aligned to the ninth printhead 9, the gap between the fifth printhead 5 and the sixth printhead 6 is substantially aligned to the tenth printhead 17, and the gap between the ninth printhead 9 and the tenth printhead 17 is substantially aligned with the fifth printhead 5. Each printhead configuration can be any of the configurations described above. During printing, the drum 20 rotates and each printhead moves back and forth along the direction 11. Due to the alignment of the printheads in rows 1 and 2 and the filling of the gaps between the printheads in the same row with the printheads in the other rows, each printhead can cooperatively print a region of the image with a corresponding aligned printhead, and each printhead only needs to move a printhead width, without having to move a printhead width plus the distance between the printheads. a printhead length plus the distance between the printheads. This is also more efficient than the printing shown in FIG. 20.

In other embodiments, the printheads can be stationary, and the printing medium moves in the first direction while rotating. It can be understood for those skilled in the art that this can also apply to cases described above and achieve the same technical results.

The technical features of the embodiments described above can be combined arbitrarily. To simplify the description, not all possible combinations of the technical features in the embodiments described above are included here. However, as long as there is no contradiction in the combination of these technical features, all should be considered within the scope of this invention.

The embodiments described above only presented several preferred practices of the present invention, which are described in more details. However, they should not be understood as limiting the scope of the present invention. It should be noted that, for those skilled in the art, as long as not departing from the concept of the present invention, all belong to the protection scope of the present invention. Therefore, the protection scope of the current invention shall be subject to the appended claims.

1. A printing apparatus comprising:
n printheads arranged along a first direction, each printhead being in fluid communication with at least two different inks;
a printing medium arranged opposite to the printhead, the printing medium including s printing areas divided along the first direction such that each printing area is configured to be printed by a printhead, wherein the printing medium is configured to rotate around a rotational axis;
a motion controller that controls the motion of the printheads and the motion of the printing medium; and
a printing driver that controls the printing of the printheads wherein s and n are positive integers greater than 1.

2. The printing apparatus of claim 1, wherein each printhead includes at least two printing units, each printing unit is in communication with one ink, and corresponding printing units in different printheads are in fluid communication with a same ink.

3. The printing apparatus of claim 2, wherein each printing unit includes at least one row of nozzles, and the nozzles in each row are arranged along the first direction.

4. The printing apparatus of claim 2, wherein each printing unit includes at least one row of nozzles, and the nozzles in each row are arranged along a direction that is inclined at an angle with respect to the first direction.

5. The printing apparatus of claim 2, wherein each printing unit includes at least two rows of nozzles, the nozzles in each row being arranged along the first direction and separated from other rows along a direction perpendicular to the first direction, and wherein two adjacent rows of nozzles are staggered along the first direction.

6. The printing apparatus of claim 2, wherein the printing units are arranged along the first direction.

7. The printing apparatus of claim 2, wherein the printing units are arranged along a second direction extending at an angle with respect to the first direction.

8. The printing apparatus of claim 2, wherein each of the printing units has a length e along the first direction, and the printing medium has a length m along the first direction, where e is less than m/n.

9. The printing apparatus of claim 1, wherein the printing medium is cylinder shaped or conical frustum shaped.

10. The printing apparatus of claim 1, the printing medium having a conical frustum shape with a rotational axis, wherein the rotational axis is inclined relative to the first direction such that a printing distance between the printheads and the printing medium is substantially constant.

11. The printing apparatus of claim 1, wherein the rotational axis is in a same plane with the straight line along first direction, and wherein an intersection of the plane and the surface of the printing medium closest to the printhead is parallel to the first direction.

12. The printing apparatus of claim 1, wherein the printing apparatus includes a drum, and the printing medium is fitted on the drum.

13. The printing apparatus of claim 1, wherein all the s printing areas have a same length along the first direction.

14. The printing apparatus of claim 14, wherein a distance between two adjacent printheads is equal to the length of the printing area.

15. The printing apparatus according to claim 1, wherein adjacent printing areas partially overlap in an overlapping area, and a length of the overlapping area along the first direction is less than 50% of a length of any printing area that includes the overlapping area.

16. The printing apparatus of claim 1, wherein a printing surface of the printing medium has a circular cross section perpendicular to the rotational axis, and the rotational axis passes through the center of the circle.

17. The printing apparatus of claim 1, wherein the printheads are arranged in at least two rows along the first direction.

18. A method of printing on a printing medium that is configured to rotate around a rotational axis, the method comprising:
arranging n printheads in the first direction, each printhead being in fluid communication with at least two different inks;
connecting the printheads and the printing medium to a motion controller;
dividing the printing medium into s printing areas along the first direction;
using the motion controller to drive the printing medium to rotate around the rotational axis and to cause the printheads and the printing medium to move relatively to each other along the first direction; and
using a print driver to control the printheads to print a pattern on the printing medium, wherein each printing area is printed by a corresponding printhead.

19. The printing method of claim 19, wherein a relative displacement of the printheads and the printing medium along the first direction is equal to e/k for each rotation of the printing medium, where e is a length of one printing unit in a printhead along the first direction, and k is a positive integer greater than or equal to 1.

20. The printing method of claim 19, wherein s is less than n and wherein using the print driver to control the printheads to print a pattern on the printing medium includes controlling only s printheads to print during a single pass printing.

21. The printing method of claim 19, wherein s is greater than n and wherein using the print driver to control the printheads to print a pattern on the printing medium includes controlling, at least one printhead to print two printing areas.

22. The printing method of claim 19, wherein s equals n, all the printing areas have a same length c along the first direction, and all printheads are spaced evenly at a pitch b=c, and wherein using the print driver to control the printheads to print a pattern on the printing medium includes controlling all n printheads to start printing at a same time.

23. The printing method of claim 19, wherein s equals n, all the printing areas have a same length c along the first direction, and all printheads are evenly spaced at a pitch b that is not equal to c, and wherein using the print driver to control the printheads to print a pattern on the printing medium includes controlling the n printheads start printing sequentially based on an order of arrangement of the printheads.

24. The printing method of claim 19, wherein arranging n printheads in the first direction includes adjusting a distance between adjacent printheads.

25. The printing method of claim 25, the printing medium having a length m, wherein arranging n printheads in the first direction includes adjusting a printhead spacing pitch b such that b=m/n, and wherein dividing the printing medium into s printing areas along the first direction includes adjusting a length c of each printing area along the first direction such that c=b.
